(19) United States
(12) Patent Application Publication
(10) Pub. No.: US 2013/0325530 A1
(43) Pub. Date: Dec. 5, 2013

(54) METHOD AND SYSTEM FOR DETERMINING CUSTOMER CONVERSION

(71) Applicants: Biswajit Pal, Bangalore (IN); Ritwik Sinha, Bangalore (IN)

(72) Inventors: Biswajit Pal, Bangalore (IN); Ritwik Sinha, Bangalore (IN)

(21) Appl. No.: 13/483,785

(22) Filed: May 30, 2012

(51) Int. Cl. G06Q 30/02; G06Q 10/00

(52) U.S. Cl. 705/7.11

(57) ABSTRACT

Embodiments of the present invention disclose a method and system for determining customer conversion propensity. According to one embodiment, a source registrant group having a plurality of registered customers is identified from a database. A probability for a conversion event is then computed for each of the plurality of customers within the source registrant group is then computed. The customers within the source registrant are than categorized based on the computed probability value and a timing for the conversion event.

### BACKGROUND

Today, many businesses are implementing customer relationship management (CRM) programs for managing their interactions with clients, customers, and sales prospects. Generally, CRM programs involve the use of technology to organize, automate, and synchronize sales and marketing activities for businesses. For example, Hewlett-Packard Company offers an Academic Purchase Program (HPA), which is essentially a CRM program for customers associated with academic institutions including current or former students, parents of students, and educators. In this context, knowing or, at least, anticipating when a customer will make a purchase or “convert”, would immensely increase the effectiveness of any marketing campaign.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of the customer conversion propensity system according to an example of the present invention.

FIG. 2 is an illustration of a process flow for determining customer conversion propensity and timing according to an example of the present invention.

FIGS. 3A and 3B are simplified flow charts of the processing steps for determining customer conversion propensity and timing in accordance with an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature an designated can be included with examples of the present disclosure. The designators can represent the same or different numbers of the particular features.

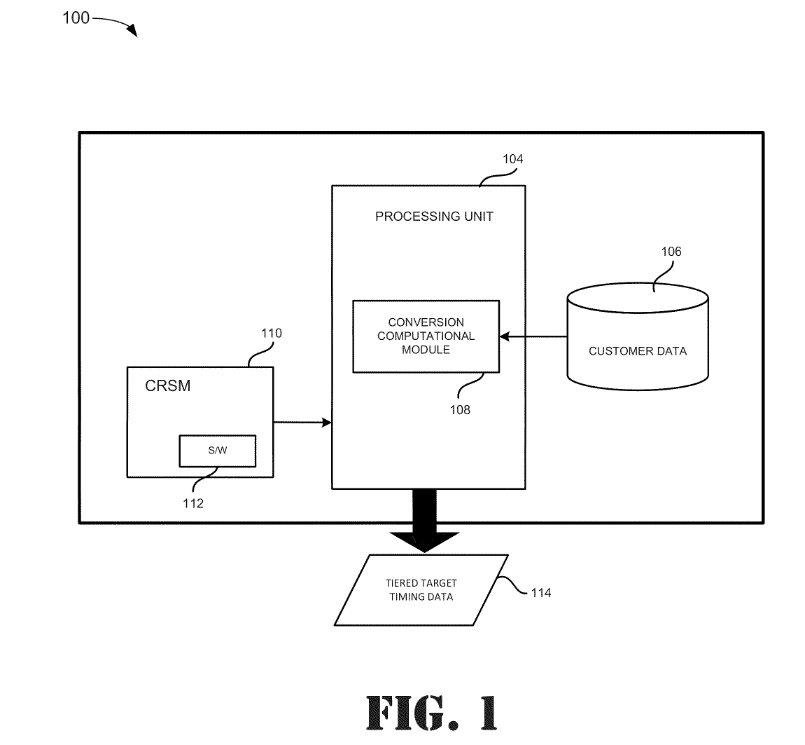

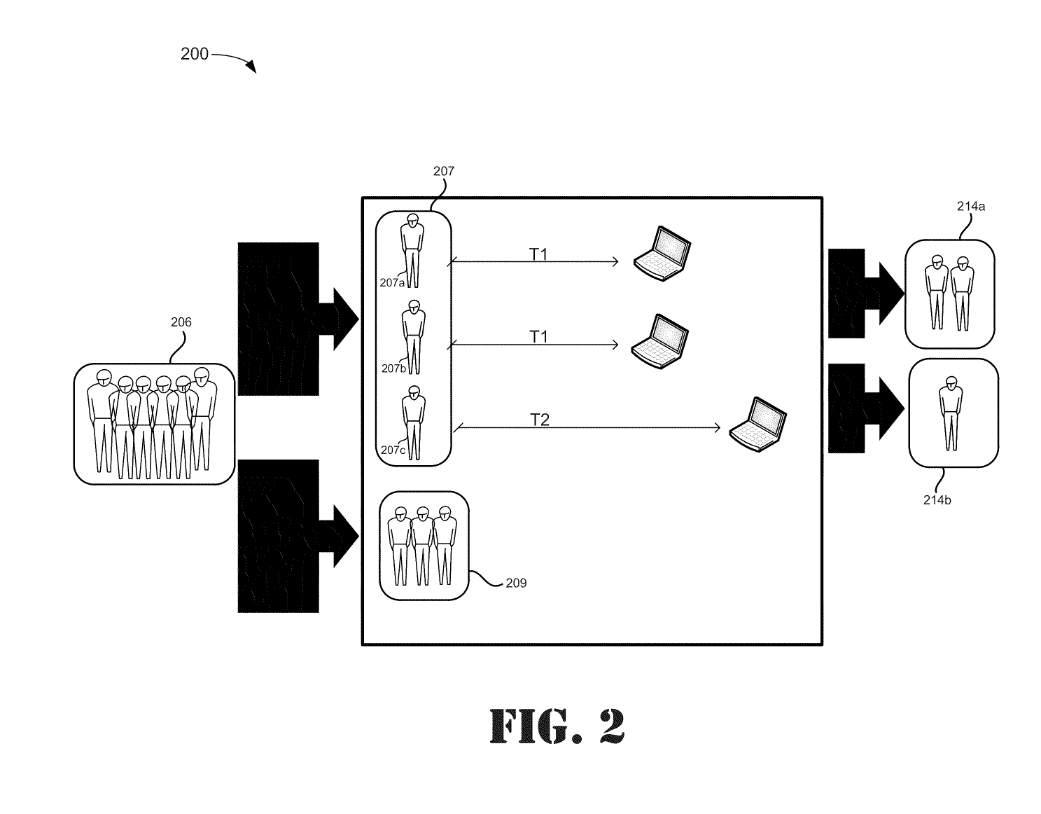

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Timing is critical in establishing an effective marketing campaign. Some examples of often asked questions include (a) time from registration to conversion, (b) time of conversion to higher value segment (e.g., from first purchase to second purchase), (c) time from campaign contact to purchase, etc. Such questions naturally lend themselves to the field of “survival analysis”; where one models the time from origin to event. A problem arises in that only a small fraction of the target audience experiences the event of interest (i.e., converts, makes first purchase, or makes second purchase). Predicting and anticipating when and whether a customer will make a purchase post registration immensely increases the effectiveness of any marketing campaign to target registrants.

The field of “survival analysis”; involves modeling the time from origin (registration date) to event (purchase date). Marketing data has suggested that only a limited proportion of the registrants go on to convert while many customers become inactive, thus lending traditional survival analyses techniques futile. Prior solutions for estimating customer conversion in the future involves modeling a binary response—“subject converts in the next k months.” For these models, however, every different k involves building and validating a separate model. Furthermore, information on subjects likely to convert in the (k+1)th time frame is not captured in such models. As such, there is a need in the art for a scalable algorithm which solves this common yet critical problem of predicting customer conversion while also being easily executable.

Embodiments of the present invention help to model the propensity of an event of interest along with the timing of said event of interest utilizing both a multivariable predictor space and a finite time horizon. One example embodiment incorporates time as a continuous variable, thus aminating the inherent discrete nature of the existing approaches to such problems. Moreover, the yielded results are meaningful and offer an intuitive and easily implementable targeting framework.

Referring now in more detail to the drawings in which like numerals identify corresponding parts throughout the views. FIG. 1 is a simplified block diagram of the system for determining customer conversion propensity according to an example of the present invention. As shown in this example, the system 100 includes a processing unit 104, a conversion computational module 108, customer data 106, and a computer-readable storage medium 110. In one embodiment, processor 104 represents a central processing unit (CPU), microcontroller, microprocessor, or logic configured to execute programming instructions associated with the touch-enabled device and computing system 100. Customer data 106 represents individuals that are registered with an organization or program of interest (e.g., HP Academic Purchase Program). The conversion computation module 108 is configured to compute both the propensity that a registered customer will convert, or reach an event of interest such as upgrade their current computing device (i.e., conversion propensity/probability), in addition to the timing for when a particular customer will convert (i.e., conversion timing). The processing unit 104 is also configured to create tiered target timing data 114 based on the conversion propensity and conversion timing as will be described in further detail with respect to FIG. 2. Storage medium 110 represents volatile storage (e.g. random access memory), non-volatile store (e.g. hard disk drive, read-only memory, compact disc read only memory, flash storage, etc.), or combinations thereof. Furthermore, storage medium 110 includes software 112 that is executable by processor 104 and, that when executed, causes the processing unit 104 to perform some or all of the functionality described herein. For example, the conversion computational module 108 may be implemented as executable software within the storage medium 110. The system for determining customer conversion may be implemented via a Statistical Analysis System (SAS) macro language or through similar programming languages and techniques.

FIG. 2 is an illustration of a process flow for determining customer conversion propensity and timing according to an example of the present invention. As shown here, the system 200 includes a group of registrants 206 stored in the customer database. The conversion computational module calculates the probability of conversion from the original registrant group 206. According to one example, the front-end model may involve a Mixture Cure modeling technique for processing customer information. For instance, modeling may involve jointly estimating the event of interest through logistic regression and predicting the time of conversion through a parametric survival analysis approach. More particularly and in accordance with one example embodiment, the logistic regression model may generate an equation of this form which gives the likelihood of conversion at an customer level sales pipeline value for a given week:

Probability of conversion=1/(1+exp{−(α+α₁*Q₁+α₂*Q₂+α₃*Q₃)})

Where Qₓ equals an attribute of the customer or customer profile, and αₓ equals an estimated weight for a particular customer/profile attribute or average conversion propensity. The table below includes an example of attributes and weights that may be considered in computing the probability or propensity for conversion:

| | Weight |
|---|---|
| Customer Profile Attribute (Qx) | Estimate (α) |
| A purchase of Electronics, Computing, & Home | 0.1883 |
| Office products has occurred within the last 24 | |
| months in the Household | |
| Household uses Credit Card | 0.1542 |
| Income is between $30000 & $60000 | 0.0432 |
| Income is less than $30,000 | −0.1509 |
| If income is greater than $100,000 | 0.106 |
| Have male children between age 16-17 in household | 0.1443 |

Additionally, the probability of conversion may also take into account the registrant's current tier/status with the organization, age, sex, employment and marital status, etc. According to one example embodiment, the values (Q_{X}) may be flagged as a 1 by the processing system if the condition/attribute is satisfied, or as 0 if the condition/attribute is not satisfied. Based on the probability of conversion, the system will divide the registrant group 206 into at least two disparate groups: a registrant group likely to convert 207 and a registrant group less likely to convert 209. The division of the registrant group 206 may be based on the probability of conversion exceeding a threshold value. For example, if the probability of conversion for an individual customer is greater than fifty percent, then that particular customer or registrant will be flagged as one likely to convert and placed within high conversion propensity group 207. Conversely, those registrants identified as having a probability of conversion less than fifty percent as belonging to the low conversion propensity group 209. According to one example, the system may then determine the time it will take each customer (e.g., 207a-207c) within the high conversion propensity group 207 to convert or reach the event of interest. The time of conversion for a particular registrant may be generated from the survival model using the following formula:

Time of conversion=σ*log(log (2))+(α+α₁*P₁+α₂*P₂+α₃*P₃)

Where Pₓ equals an attribute of the customer and a, equals an estimated weight for a particular customer attribute or average conversion propensity (α). The parameter σ is a Weibull parameter which gets estimated from the data. The table below includes an example of attributes and weights that may be considered in computing the timing for conversion:

| | Weight |
|---|---|
| Customer Profile Attribute (Px) | Estimate (a) |
| Age of an individual is less than 30 | −0.3031 |
| Household includes female children between age | −0.1048 |
| 16-17 in household | |
| Household includes male children between age | −0.08682 |
| 16-17 in household | |
| Someone in the household has an interest in | 0.1429 |
| photography. | |
| Income is greater than $100,000 | 0.0487 |

The timing for conversion may also take into account the registrant's current tier/status with the organization, employment and marital status, etc. As in the computation for the propensity to convert, here the values (P_{X}) may be flagged as a 1 by the processing system if the condition/attribute is satisfied, or as 0 if the condition/attribute is not satisfied. Given a time of conversion for each identified customer, the system may further divide the high conversion propensity group 207 into registrant(s) that are converting within a first time frame and those converting within a second time frame (though multiple time frames may be used). As seen in the example of FIG. 2, the system has determined that registrants 207a and 207b will likely convert at time T1, while registrant 207c will likely convert at a later time, T2. As such, the processing unit may further divide registrant group 207 into a first conversion timing group 214a and a second conversion timing group 214b. A tiered targeted timing structure may then be established to correspond with groups 214a and 214b and timing associated with each group. For example, seasonality is a high driving factor and the system may be used to determine a higher conversion rate during back to school periods for student/parent registrants against non-student registrants during the same time period. Moreover, by jointly modeling the propensity of a customer to convert and the time a customer takes to convert, the non-converter's effect on converter's conversion period (interaction effect) is not taken into consideration unlike previous solutions. Furthermore, the system may be configured to utilize all available information about a customer and customer profile to build a predictive model for obtaining a targeting framework (e.g., age, income, marital status, purchase history, age of children in household, etc.).

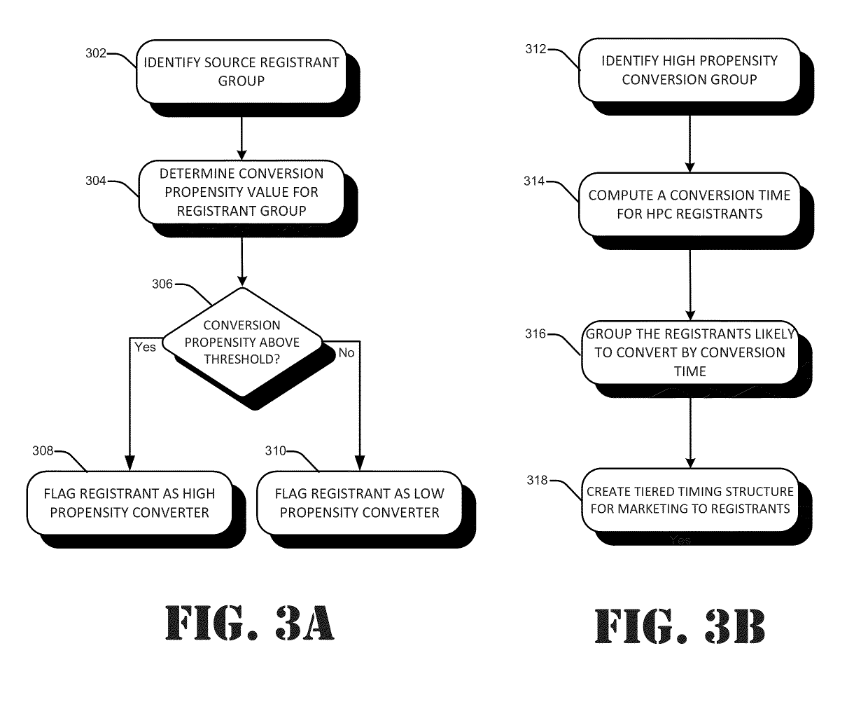

FIGS. 3A and 3B are simplified flow charts of the processing steps for determining customer conversion propensity and timing in accordance with an example of the present invention. FIG. 3A are processing steps for determining the conversion propensity. In step 302, the processing unit receives a request and identifies source registrants stored in the database. The source registrant group may include all registrants stored in the database or simply a subset of registrants, and the request may be initiated from an administrator or user of the system. Next, in step 304, the processing unit and/or conversion computational module determines the conversion propensity or probability value for each of the identified registrants with the source group. If the processing unit determines in step 306 that the conversion propensity or probability is above a threshold value (e.g., 50%), then the particular registrant is flagged and grouped as a high propensity converter. Conversely, if the conversion probability is lower than the threshold value, then the processing unit flags and groups the registrant as a low propensity convertor.

FIG. 3B is a simplified flow chart of the processing steps for determining conversion timing of customers deemed to have a high propensity for conversion. In step 312, the processing unit identifies those registrants belonging to the high propensity conversion group. For each registrant within this group, in step 314 the conversion computational module computes an estimated time for conversion as described above. The registrants identified as high propensity converters may then be grouped by their respective conversion time in step 316. For example, registrants may be grouped by those likely to convert within 3 months, 6 months, one year, etc. Thereafter, the system is configured to create a recommended tiered timing structure for use as a targeting framework for future advertising campaigns to registrants deemed to have a higher propensity for conversion.

Embodiments of the present invention provide a novel targeting framework for predicting time from registration to conversion for customers. Moreover, many advantages are afforded by the system and method in accordance with embodiments of the present invention. For example, example embodiments dually models the propensity of a customer to convert as well as the time a customer takes to convert utilizing both a multivariate variable space and a finite time horizon. Thus, embodiments of the present invention may be used to aid in solving common marketing problems like predicting the time taken from first purchase to second purchase or the time from campaign contact to purchase, etc.

Furthermore, while the invention has been described with respect to exemplary embodiments, one skilled in the art will recognize that numerous modifications are possible. For example, although exemplary embodiments depict purchase of a notebook computer as the conversion event, the invention is not limited thereto. For example, the conversion event may involve software download or other electronic devices, apparel, cloud or similar services, or any product or service offered by a vendor. Thus, although the invention has been described with respect to exemplary embodiments, it will be appreciated that the invention is intended to cover all modifications and equivalents within the scope of the following claims.

1. A method comprising:
identifying, via a processing unit coupled to a database, a source group of customers from the database;
calculating, via the processing unit, a probability value for a conversion event for each of the plurality of customers within the source registrant group;
categorizing, via the processing unit, the plurality of customers, the categorizing including,
assigning, via the processing unit, customers having a probability value above a threshold value to a high conversion propensity group; and
assigning, via the processing unit, customers having a probability value below the threshold value to a low conversion propensity group; and
after the categorizing; and
calculating, by the processing unit, a conversion timing for each of the customers within the high conversion propensity group.

2. The method of claim 1 conversion timings are not calculated for customers in the low conversion propensity group.

3. (canceled)

4. The method of claim 1 further comprising: allocating, by the processing unit, customers within the high propensity conversion group into one or more targeting groups based on the conversion timing for each customer.

5. The method of claim 4, further comprising
creating, via the processing unit, a tiered timing structure for marketing to customers based on the one or more targeting groups.

6. The method of claim 1 wherein customers within the low conversion propensity group are not targeted for marketing.

7. The method of claim 1, wherein the conversion event represents a time from online registration to a first purchase of a product or service, or a time from the first purchase to a second purchase of a product or service.

8. A system of determining customer conversion propensity, the system including:
a database for storing data characterizing each of a plurality of customers;
a conversion computational module to,
compute a probability value of a conversion event for each of the plurality of customers, and
after a high-propensity group of customers is identified, compute a conversion timing for each of the customers in the high-propensity group; and
a processing unit to categories the customers so as to form the high-propensity group and a low-propensity group from the data based on the probability value of the conversion event for each of the plurality of customers within the source registrant group.

9. The system of claim 8, wherein first conversion grouping includes at one or more customers having a probability value above a threshold value and the second conversion grouping includes customers having a probability value below the threshold value.

10. The system of claim 8 wherein conversion timings are not computed for customers within the low-propensity group.

11. The system of claim 10, wherein customers within the high-propensity group are further grouped into a first targeting group and a second targeting group based on the computed conversion timing for each customer within the first conversion grouping.

12. The system of claim 11, wherein the processing unit is further to create a tiered timing structure for marketing based on the first targeting group and the second targeting group.

13. The system of claim 9, wherein customers within the low-propensity group are not targeted for marketing.

14. The system of claim 8, wherein the conversion event represents a time from online registration to a first purchase of a product or service, or a time from the first purchase to a second purchase of a product or service.

15. A non-transitory computer readable storage medium having stored executable instructions, that when executed by a processor, causes the processor to:
identify a source registrant group from the database, wherein the source registrant group includes a plurality of customers;
calculate a probability value for a conversion event for each of the plurality of customers within the source registrant group;
categorize the plurality of customers within the source registrant group into a high-propensity group and a low-propensity group based on the conversion probability value; and
after the categorizing, calculating a conversion timing for each of the customers within the high conversion propensity group.

16. The computer readable storage medium of claim 15, wherein the executable instructions further cause the processor to:
assign customers having a probability value above a threshold value to high-propensity group; and
assign customers having a probability value below the threshold value to the low-propensity group.

17. The computer readable storage medium of claim 16, wherein conversion timings are not computed for customers within the low-propensity group.

18. The computer readable storage medium of claim 15, wherein the executable instructions further cause the processor to:
allocate customers within the first conversion group into separate targeting groups based on the conversion timing for each customer.

19. The computer readable storage medium of claim 18, wherein the executable instructions further cause the processor to:
create a tiered timing structure for marketing based on the allocated targeting groups.

20. The computer readable storage medium of claim 15,
wherein the conversion event represents a time from online registration to a first purchase of a product or service, or a time from the first purchase to a second purchase of a product or service.
